(19) United States
(12) Patent Application Publication
(10) Pub. No.: US 2003/0084454 A1
(43) Pub. Date: May 1, 2003

(54) Media device rental system

(76) Inventors: Barry Henthorn, Seattle, WA (US); Sean Lamont, Seattle, WA (US)

Correspondence Address: Barry Henthorn, 2100 Westlake Ave. N., Seattle, WA, 98109, US

(21) Appl. No.: 09/999,772

(22) Filed: Oct. 25, 2001

(51) Int. Cl. H04N 7/173

(52) U.S. Cl. 725/87; 725/94; 725/105

(57) ABSTRACT

An on demand media device rental system includes a plurality of media devices where an individual rented one of the media devices is responsive to a user controlled remote control device that facilitate the accessing and controlling of the playback of a user selected media source that is disposed in the individual rented one of the media devices.

### BACKGROUND OF THE INVENTION

The present invention relates generally to telecommunications and, more particularly, to systems wherein media and media devices are rented.

Businesses, in the form of media rental stores, are popular and satisfy a need among users for a way to enjoy media at relatively low cost. Typically, a user rents a videocassette or digital videodisc (DVD) for a short period of time for viewing at a home or other location. The process offers several advantages. One advantage is flexibility afforded the user as to times of viewing, during the rental period. Another is control over the viewing process whereby the user can pause, or replay the media at will.

While the present system affords several advantages, it also has limitations. For example, the process typically requires a trip to the store for selection and rental of the product, and another trip to return it. At times, this can be a burden for the user, especially in cases where the product is not returned on time and overtime charges accrue.

Additionally, limited inventories at the rental store sometimes result in outages, precluding the user from renting a desired cassette or DVD. Further, the product may be flawed and this problem is not discovered until the user attempts to play it, after it has been rented.

From the foregoing it will be apparent that there is a need for a rental system that can provide user access to media while eliminating a trip to a rental store. Desirably, such a system would present the user with the flexibility of conventional systems while having a high degree of predictability

### SUMMARY OF THE INVENTION

According to the present invention, there is provided an on demand media device rental system which includes a plurality of rentable media devices that when rented respond to a user controlled remote control device that facilitates the accessing and controlling of the playback of a user selected media source that has been loaded into the individual media device rented by the user. A set top box coupled to a user controlled television device is responsive to the user controlled remote control device to cause a library of available media sources to be displayed for user selection purposes and transmits the remote command signals produced by the remote control device to the rented media device for a user selected rental period of time. A server system coupled between the plurality of media devices and the set top box, couples the remote command signals transmitted by the set top box to the rented media device to enable the user to access and control the playback of the user selected media source and couples the playback of the media source to the set top box to enable the user to controllably view the playback of the media source during the user selected rental period of time.

### BRIEF DESCRIPTION OF THE DRAWINGS

The above mentioned features of the invention and the manner of attaining them will become apparent, and the invention itself will be best understood by reference to the following description of the embodiments of the invention in conjunction with the accompanying drawings wherein:

FIG. 1 is block diagram of a media device rental system that is constructed in accordance with the present invention;

FIG. 2 is a diagrammatic view of a translation system illustrated in the block diagram of FIG. 1;

FIG. 3 is a block diagram of a set top box of FIG. 2; and

FIG. 4 is a flow chart of the steps performed by the media device rental system of FIG. 1.

### DETAILED DESCRIPTION OF THE PREFERRED EMBODIMENT

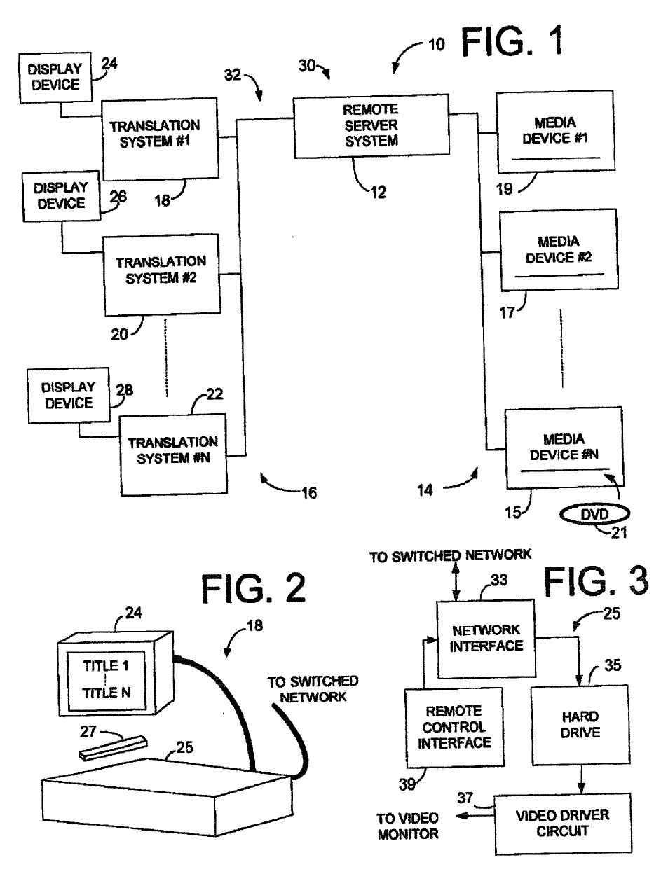

Referring now to the drawings and more particularly to FIG. 1 thereof, there is shown a block diagram of a media device rental system 10, which is constructed in accordance with the present invention. The media device rental system 10 is a “virtual rental” system that enables an individual to rent on-line, for a user selected period of time, a media device and a user selected digital video disc (DVD). In short, the media device rental system 10 provides a user with the ability to access and control the playback of the user selected DVD during the user selected rental period.

According to the preferred embodiment of the present invention, the media device rental system 10 includes a server system 12 that is coupled between a group 14 of media devices, such as media devices 15, 17 and 19 and a group 16 of translation systems, such as translation systems 18, 20, and 22. The server system 12 and the group 14 of media devices are located at a video on demand distribution center 30, while the individual translation systems, such as translation systems 18, 20 and 22, are located at individual user locations such as the home of a user, a hotel room, or a business conference room. As will be explained hereinafter in greater detail, the media device rental system 10 provides a user with the ability to access and control the playback of a user selected digital video disc, such as a digital video disc 21, from the comfort of a home, an office, or a hotel room, or wherever the user has access to a display device, such as a television 24 and a translation system, such as the translation system 18.

Considering now the translation systems 18, 20, and 22 in greater detail, only translation system 18 will be described in greater detail, since each translation system is substantially identical. Referring now to FIGS. 1 and 2, the translation system 18 is coupled to the server system 12 via an optical cable network 32 and cooperates with the server system 12 where they function together in the same manner as a switched digital network.

The translation system 18 is a remote-control menu based system that generally includes a set top box 25 and a remote control device 27. The device 27 may be, for example, an infrared or a radio frequency control device. The translation system 18 enables a user to select a desired digital video disc (DVD) and to control the playback of the DVD using the remote control device 27. In this regard, once the user has rented a media device, such as the media device 15, and selected a desired DVD, the DVD itself, such as DVD 21, is in the exclusive domain of the user. That is, the user can playback the DVD 21, restart the DVD 21, jump to selected scenes, view credits, trailers, and control the DVD 21 using all of the operation options that are otherwise available on the media device 15.

As best seen in FIG. 3, the set top box 25 includes a network interface module 33 that transmits and receives digital information via the optical cable network 32, a hard drive 35 that stores the titles of the various DVDs that are available for viewing, and a video driver circuit 37 that enables the signals from the hard drive 35 to be translated into video signals suitable for displaying the titles on a television or a video monitor. A remote control interface module indicated generally at 39, receives remote control signals from the remote control device 27 and converts the remote control signals into digital signals that are transmitted to the server system 12 via the network interface module 33 and the optical cable network 32. The hard drive 35 is also coupled to the network interface module 33 so that as new titles are made available on the media device rental system 10, the new titles can be uploaded to the hard drive 35 for user selection purposes. The network interface module 33, the hard drive 35, the video driver circuit 37 and the remote control interface module 39 are conventional in nature and well understood by those skilled in the art. Accordingly, they and their operation will not be described hereinafter in greater detail. It should suffice to indicate that only titles are stored on the hard drive 35, while the actual playback digital signals produced by the DVD are directly coupled to the television or the video monitor, whichever the case may be, via the network interface module 33 and the video driver circuit 37.

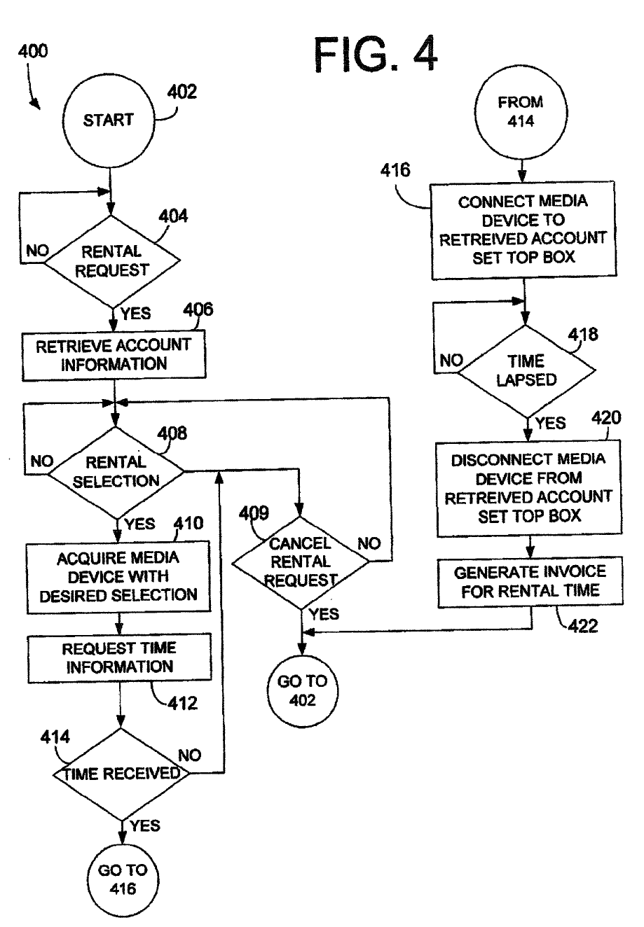

Considering now the operation of the media device rental system 10 in greater detail with reference to FIG. 4, the server system 12 includes the necessary firmware and software to control the media device selection operations and the generating of invoices for rental time selected by user. As best seen in FIG. 4, a media device operations program 400 begins at a start command 402 whenever the server system 12 is powered up. The server system 12 then advances to a determination step 404 that seeks to query whether a user of any one of the translation systems 18, 20, or 22 has requested rental time on one of the media devices, such as the media devices 15, 17 and 19. If not, the program loops at step 404 until such a request is received.

Once a rental request is received, the program advances to a retrieval step 406 that causes the account information for the user to be retrieved. In this regard, the rental request signal is encoded with sufficient information to enable the server system 12 to identify the source of the request for billing purposes and for enabling a desired video stream to be transmitted to the requesting translation system, such as the translation system 18.

After the account has been retrieved, the program advances to a determination step 408 to determine whether the user has made a DVD selection from the available titles that have previously been stored on the hard drive 35. If a DVD selection signal has not been received the program advances to a query step 409 to determine whether the user of the requesting translation system 18 has requested to cancel the media device rental request. If so, the program returns to the start step 402 and proceeds as described previously. If the user has not cancelled the rental request the program returns to the rental request inquiry step 408 and proceeds as described previously.

When the user makes a DVD selection, the program advances from the rental request step 408 to a command step 310 that acquires and dedicates an individual one of the media devices, such as the media device 15, that has been disposed thereon the desired DVD selection requested by the user. The program then advances to a command step 412 that causes a time request signal to be generated and sent to the requesting translation system. In this regard, the server system 12 makes an inquiry as to the amount of time the user desired to rent the media device 15 with the user selected DVD. While the system imposes no time limits on the user, a typical rental period is between about 30 minutes and about 1440 minutes.

The program then advances to a determination step 414 to determine whether the user of the requesting translation system 15 and provided the necessary rental time information. If not, the program returns to determination step 409 and proceeds as described previously. On the other hand, if the user of the requesting translation system 15 has provided the rental time information, the program proceeds to a command step 416 that connects the acquired media device, such as the media device 15 to the retrieved account set top box, such as the set top box 25 of translation system 18. In this regard, the user now has complete control of the acquired media device 15, and the selected DVD 21 for the period of time selected by the user.

The program then goes to a determination step 418 to determine whether the rental time period has lapsed. If the rental time period has not lapsed, the program loops at the determination step 418 for the rental period to lapse. In this regard, when the rental time period lapses, the program proceeds to a command step 420 that causes the acquired media device 15 to be disconnected from the retrieved account set top box 25.

The program then advances to a command step 422 that generates a customer invoice for the time the media device 15 and the selected DVD 21 were rented and supplies this information to the distribution center-billing department so that the incurred charges can be invoiced to the user. For example, the rental charges can be deducted from a user provided credit card number, or added to room charges if the user is residing in a hotel room. In any event, the user is billed for the time the user rented the media device 15.

Once the user has been invoiced the program returns to the start command where the program proceeds as described previously.

While particular embodiments of the present invention have been disclosed, it is to be understood that various different modifications are possible and are contemplated within the true spirit and scope of the appended claims. For example, while an optical digital switched network was described, it is contemplated that other communication paths can be established, such as a satellite communication path. As another example, while the translation system was described as having a hard drive storage device other types of storage devices are contemplated such as a RAM storage device, or a m-RAM storage device. Therefore, there is no intention of limitations to the abstract, drawings or disclosure herein presented.

What is claimed is:

1. A media rental system, comprising:
at least one on demand media device responsive to remote command signals for accessing and controlling the playback of a media source inserted in the media device;
at least one translation system responsive to the remote command signals for causing a library of available media sources to be communicated for selection purposes and for transmitting the remote command signals to the media device; and
a server system coupled between said media device and said translation system for coupling the remote command signals to the media device to facilitate accessing and controlling the playback of said media source and for coupling the playback of said media source to said translation system for a user selected rental period of time.

2. The media rental system according to claim 1, wherein said on demand media device is a digital video device for the playing of compact discs and digital video discs.

3. The media rental system according to claim 1, wherein said user selected rental period of time is a sufficient time to view the complete playback of said media source.

4. The media rental system according to claim 3, wherein a sufficient time is between about 30 minutes and about 1440 minutes.

5. A method of renting a media device, comprising:
providing at least one on demand media device responsive to remote command signals for accessing and controlling the playback of a media source inserted in the media device;
providing at least one translation system responsive to the remote command signals for causing a library of available media sources to be communicated for selection purposes and for transmitting the remote command signals to the media device; and
providing a server system coupled between said media device and said translation system for coupling the remote command signals to the media device to facilitate accessing and controlling the playback of said media source and for coupling the playback of said media source to said translation system for a user selected rental period of time.

6. A media rental system, comprising:
a plurality of media device means responsive to remote command signals for accessing and controlling the playback of a user selected media source inserted in an individual ones of said plurality of media device means;
translation system means responsive to the remote command signals for causing a library of available media sources to be communicated for user selection purposes and for transmitting the remote command signals to an individual one of said media device means rented by a user for a user selected rental period of time; and
server system means coupled between said plurality of media device means and said translation system means for coupling the remote command signals to an individual one of the media device means rented by said user to facilitate accessing and controlling the playback of said media source and for coupling the playback of a user selected media source to said translation system means for said user selected rental period of time.

7. A translation system, comprising:
a set top box for transmitting digital information to a remote distribution center to facilitate the coupling of a media device having a user desired media source to a user controlled display device; and
a remote control device for generating media device control information to enable a user to control said media device during a user selected period of time, said user selected period of time being a rental period of time indicative of the time the user has control of said media device and its associated user desired media source.

8. The translation system according to claim 7, wherein said set top box includes a remote control interface module for receiving the media device control information.

9. The translation system according to claim 7, wherein said remote control device further generates account information and rental time information to help facilitate invoicing the user for the time the user had control of said media device and its associated user desired media source.

10. The translation system according to claim 7, wherein said set top box includes a storage device for storing title information indicative of media source titles.

11. The translation system according to claim 10, wherein said set top box includes a network interface module that facilitates transmitting and receiving digital information.

12. The translation system according to claim 11, wherein said network interface module includes control means for coupling received digital information indicative of said media source to a user controlled display device and for coupling received digital information indicative of the media source title information to said storage device.

13. The translation system according to claim 12, wherein said storage device is a hard drive.

14. A media device rental system, comprising:
a server system for controlling the selection of individual ones of a plurality of media devices preloaded with user desired media sources; and
a translation system for directing media device control information to an individual one of the media devices preloaded with a user desired media source and for coupling the content of said user desired media source to a user controlled display device.

15. The media device rental system, according to claim 14, wherein said translation system includes:
a set top box for transmitting digital information to a remote distribution center to facilitate the coupling of an individual one of the media devices having a user desired media source to said user controlled display device; and
a remote control device for generating the media device control information to enable a user to control the individual one of the media devices having a user desired media source during a user selected period of time, said user selected period of time being a rental period of time indicative of the time the user has control of said media device and its associated user desired media source.

16. The media device rental system according to claim 15, wherein the time the user has control of said media device and its associated user desired media source is a rental period of time.

17. The media device rental system according to claim 16, wherein said rental period of time is between about 30 minutes and about 1440 minutes.

18. The media device rental system according to claim 15, wherein said remote control device is a radio frequency control device.

19. The media device rental system according to claim 15, wherein said remote control device is an infrared wavelength control device.

20. A media device rental system, comprising:
a plurality of media devices, said media devices being periodically loaded with media source in the form of digital video discs; and
a control system for coupling a user selected one of said plurality of media devices having a desired media source loaded therein to a translation system capable of generating media device control signals to control the viewing of said desired media source for a user selected period of time.
